(19) United States
(12) Patent Application Publication
(10) Pub. No.: US 2017/0287643 A1
(43) Pub. Date: Oct. 5, 2017

(54) Method of Producing Multi-Layer Ceramic Electronic Component and Multi-Layer Ceramic Electronic Component

(71) Applicant: Taiyo Yuden Co., Ltd., Tokyo (JP)

(72) Inventors: Joji Kobayashi, Tokyo (JP); Toshimitsu Kogure, Tokyo (JP); Yasunari Kato, Tokyo (JP); Hidenori Wakayanagi, Tokyo (JP); Yosuke Sato, Tokyo (JP)

(21) Appl. No.: 15/474,351

(22) Filed: Mar. 30, 2017

(30) Foreign Application Priority Data
Mar. 30, 2016 (JP) 2016-067679

(51) Int. Cl. H01G 4/30; H01G 4/12; H01G 4/248; H01G 4/012

(52) U.S. Cl. CPC H01G 4/30; H01G 4/012; H01G 4/12; H01G 4/248

(57) ABSTRACT

A method of producing a multi-layer ceramic electronic component includes: preparing a multi-layer chip including ceramic layers laminated in a first axis direction, internal electrodes disposed between the ceramic layers, and a side surface on which the internal electrodes are exposed; applying a ceramic paste to the side surface; and pressing the applied ceramic paste toward the side surface to planarize the applied ceramic paste.

### CROSS REFERENCE TO RELATED APPLICATION

This application claims priority under 35 U.S.C. §119 to Japanese Patent Application No. 2016-067679, filed Mar. 30, 2016, which is herein incorporated by references in its entirety.

### BACKGROUND

The present invention relates to a method of producing a multi-layer ceramic electronic component including side margins provided in a subsequent step, and to a multi-layer ceramic electronic component.

Along with miniaturization of electronic devices and achievement of high performance thereof, there have recently been increasingly strong demands for miniaturization and increase in capacity with respect to multi-layer ceramic capacitors used in the electronic devices. In order to meet those demands, it is effective to enlarge internal electrodes of the multi-layer ceramic capacitor. In order to enlarge the internal electrodes, it is necessary to thin side margins for ensuring insulation properties of the periphery of the internal electrodes.

Meanwhile, in a general method of producing a multi-layer ceramic capacitor, it is difficult to form side margins having a uniform thickness because of precision in each step (e.g., patterning of internal electrodes, cutting of a multi-layer sheet, etc.). Thus, in such a method of producing a multi-layer ceramic capacitor, as the side margins are made thinner, it is more difficult to ensure insulation properties of the periphery of the internal electrodes.

Japanese Patent Application Laid-open Nos. 2012-191164 and 2012-209538 disclose a technique of providing side margins in a subsequent step. In other words, in this technique, a multi-layer chip including internal electrodes exposed to side surfaces of the multi-layer chip is produced by cutting a multi-layer sheet, and side margins are then provided to the side surfaces of the multi-layer chip by applying a ceramic paste to the side surfaces of the multi-layer chip. This makes it possible to reliably form side margins and thus makes it easy to ensure insulation properties of the periphery of the internal electrodes.

### BRIEF SUMMARY

However, when the side margins are formed using the ceramic paste, it has been difficult to provide the ceramic paste in a uniform thickness on the side surfaces of the multi-layer chip, as described in the paragraphs [0065] and [0007] of Japanese Patent Application Laid-open No. 2012-209538. Further, also when the ceramic paste is applied by the method described in Japanese Patent Application Laid-open No. 2012-209538, it has been difficult to control the thickness of the side margins to be made uniform. If the thickness of the side margin is not uniform, a part of the side margin protrudes, and this hinders the miniaturization of the multi-layer ceramic capacitor and may also make it difficult to sufficiently ensure insulation properties of the periphery of the internal electrodes.

In view of the circumstances as described above, it is desirable to provide a method of producing a multi-layer ceramic electronic component and a multi-layer ceramic electronic component, which are capable of sufficiently ensuring insulation properties of the periphery of internal electrodes while achieving miniaturization.

According to an embodiment of the present invention, there is provided a method of producing a multi-layer ceramic electronic component, the method including: preparing a multi-layer chip including ceramic layers laminated in a first axis direction, internal electrodes disposed between the ceramic layers, and a side surface on which the internal electrodes are exposed; applying a ceramic paste to the side surface; and pressing the applied ceramic paste toward the side surface to planarize the applied ceramic paste.

With this configuration, even when the ceramic paste immediately after being applied has a non-uniform thickness due to surface tension or the like, planarization of the ceramic paste can provide a uniform thickness. This can prevent the side margin from partially protruding, bulging, or the like, and provide the miniaturization of the multi-layer ceramic electronic component. Further, even when the ceramic paste immediately after being applied is thin at the circumference, the ceramic paste is pressed to flow to the circumference by planarization, so that the thickness of the circumferential portion can be sufficiently ensured. Therefore, insulation properties of the internal electrodes can be ensured.

Further, the side surface may be immersed in the ceramic paste to apply the ceramic paste to the side surface.

This makes it possible to simultaneously perform application treatment on a plurality of multi-layer chips and enhance productivity.

Furthermore, specifically, the ceramic paste may be pressed with a flat plate to planarize the ceramic paste.

This makes it possible to simultaneously perform pressing treatment on the plurality of multi-layer chips and enhance productivity.

The flat plate may include a release layer on a surface of the flat plate, the release layer enhancing release properties of the ceramic paste.

This makes it possible to prevent the ceramic paste and the flat plate from adhering to each other and form a side margin with a desired form by the pressing treatment. The ceramic paste may be applied and then dried.

When the ceramic paste is dried before being planarized, the ceramic paste can be easily deformed into a desired form in the planarization step.

Further, after the ceramic paste is applied to one of the side surfaces, the applied ceramic paste is dried before the other side surface is subjected to the treatment. This can prevent the ceramic paste from being deformed. This can prevent the ceramic paste from being deformed also when the one side surface is retained by an application apparatus, a planarization apparatus, or the like in treatment for the other side surface.

For a specific example of the planarization, a bulging portion of the ceramic paste may be pressed to flow to a circumference of the ceramic paste, to planarize the ceramic paste. This can reduce, when the applied ceramic paste has a bulging portion, the thickness of that portion and achieve the miniaturization of the multi-layer ceramic electronic component. Further, the thickness of the circumference of the applied ceramic paste can be sufficiently ensured, and insulation properties of the periphery of the internal electrodes can be sufficiently ensured.

For example, a length of the planarized portion along the first axis direction may be 30% or more and 70% or less of a length of the multi-layer chip along the first axis direction.

Further, for example, when the ceramic paste may be pressed in a second axis direction to be planarized, the second axis direction being orthogonal to the side surface, a length of the planarized portion along a third axis direction is 30% may be more and 70% or less of a length of the multi-layer chip along the third axis direction, the third axis direction being orthogonal to the first axis direction and the second axis direction.

According to another embodiment of the present invention, there is provided a multi-layer ceramic electronic component including a multi-layer chip and a side margin.

The multi-layer chip includes ceramic layers laminated in a first axis direction, internal electrodes disposed between the ceramic layers, and a side surface on which the internal electrodes are exposed.

The side margin is made of dielectric ceramics and provided on the side surface, the side margin including a flat portion having a predetermined thickness in a second axis direction, the second axis direction being orthogonal to the side surface, and a circumferential portion that is formed around the flat portion and has a thickness smaller than the thickness of the flat portion in the second axis direction.

With this configuration, it is possible to prevent the side margin from partially protruding, bulging, or the like, and achieve the miniaturization of the multi-layer ceramic electronic component. Further, since the circumferential portion is thinner than the flat portion, stress between the multi-layer chip and the side margin can be reduced at the circumferential portion. This can prevent the side margin from being easily peeled off and thus ensure the function of the side margin.

For example, a length of the flat portion along the first axis direction may be 30% or more and 70% or less of a length of the multi-layer chip along the first axis direction. Further, for example, a length of the flat portion along a third axis direction may be 30% or more and 70% or less of a length of the multi-layer chip along the third axis direction, the third axis direction being orthogonal to the first axis direction and the second axis direction.

As described above, according to the present invention, it is possible to provide a method of producing a multi-layer ceramic electronic component and a multi-layer ceramic electronic component, which are capable of sufficiently ensuring insulation properties of the periphery of internal electrodes while achieving miniaturization.

These and other objects, features and advantages of the present invention will become more apparent in light of the following detailed description of embodiments thereof, as illustrated in the accompanying drawings.

### BRIEF DESCRIPTION OF THE DRAWINGS

FIG. 1 is a perspective view of a multi-layer ceramic capacitor according to a first embodiment of the present invention;

FIG. 2 is a cross-sectional view of the multi-layer ceramic capacitor taken along the A-A′ line in FIG. 1;

FIG. 3 is a cross-sectional view of the multi-layer ceramic capacitor taken along the B-B′ line in FIG. 1;

FIG. 4 is a side view of a body of the multi-layer ceramic capacitor when seen from a Y-axis direction;

FIG. 5 is a flowchart showing a method of producing the multi-layer ceramic capacitor;

FIGS. 6A, 6B, and 6C are plan views of ceramic sheets prepared in Step S01 of the production method;

FIG. 7 is a perspective view of a multi-layer sheet in Step S02 of the production method;

FIG. 8 is a plan view of the multi-layer sheet after Step S03 of the production method;

FIG. 9 is a perspective view of the multi-layer chip after Step S03 of the production method;

FIG. 10 is a schematic view showing Step S04 of the production method;

FIG. 11 is a schematic view showing Step S04 of the production method;

FIG. 12 is a cross-sectional view of the multi-layer chip immediately after Step S04 of the production method;

FIG. 13 is a schematic view showing Step S05 of the production method;

FIG. 14 is a schematic view showing Step S05 of the production method;

FIG. 15 is a schematic view showing Step S05 of the production method;

FIGS. 16A and 16B are a cross-sectional view and a plan view of the multi-layer chip immediately after Step S05 of the production method, respectively;

FIG. 17 is a perspective view of the body after Step S07 of the production method;

FIG. 18 is a flowchart showing a modified example of the method of producing the multi-layer ceramic capacitor; and

FIG. 19 is a cross-sectional view of a modified example of the multi-layer ceramic capacitor.

### DETAILED DESCRIPTION

Hereinafter, embodiments of the present invention will be described with reference to the drawings.

In the figures, an X axis, a Y axis, and a Z axis orthogonal to one another are shown as appropriate. The X axis, the Y axis, and the Z axis are common in all figures.

### 1. First Embodiment

1.1 Configuration of Multi-layer Ceramic Capacitor 10

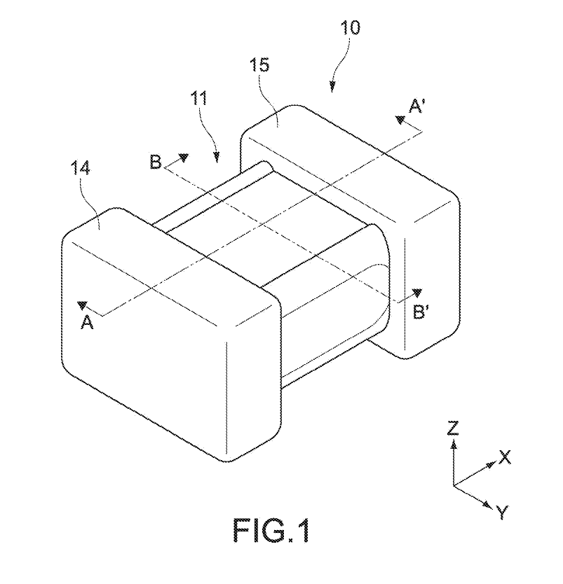

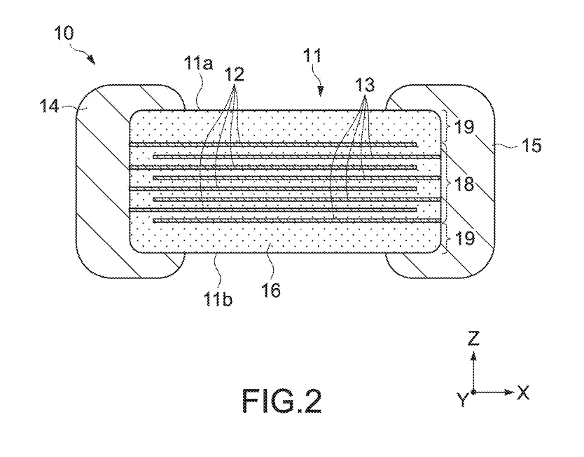

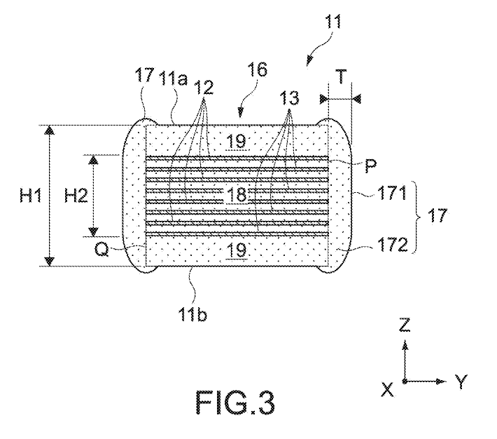

FIGS. 1 to 3 each show a multi-layer ceramic capacitor 10 according to a first embodiment of the present invention. FIG. 1 is a perspective view of the multi-layer ceramic capacitor 10. FIG. 2 is a cross-sectional view of the multi-layer ceramic capacitor 10 taken along the A-A′ line in FIG. 1. FIG. 3 is a cross-sectional view of the multi-layer ceramic capacitor 10 taken along the B-B′ line in FIG. 1.

The multi-layer ceramic capacitor 10 includes a body 11, a first external electrode 14, and a second external electrode IS. The first external electrode 14 and the second external electrode 15 are apart from each other and face each other in an X-axis direction while sandwiching the body 11 therebetween.

The body 11 has two end surfaces (not shown) oriented in the X-axis direction, two side surfaces P and Q oriented in a Y-axis direction, and two main surfaces 11a and 11b oriented in a Z-axis direction. Ridges connecting the respective surfaces of the body 11 are chamfered. In the body 11, for example, a dimension in the X-axis direction can be set to 1.0 mm and dimensions in the Y- and Z-axis directions can be set to 0.5 mm.

It should be noted that the form of the body 11 is not limited to the form as described above. For example, the surfaces of the body 11 may be curved surfaces, and the body 11 may be rounded as a whole.

The first external electrode 14 and the second external electrode 15 cover both the end surfaces of the body 11 that are oriented in the X-axis direction, and extend to both the side surfaces oriented in the Y-axis direction and both the main surfaces oriented in the Z-axis direction, both the side surfaces and both the main surfaces being connected to both the end surfaces oriented in the X-axis direction. With this configuration, both of the first external electrode 14 and the second external electrode 15 have U-shaped cross sections in parallel with an X-Z plane and an X-Y plane.

The first external electrode 14 and the second external electrode 15 are each formed from a good conductor and function as terminals of the multi-layer ceramic capacitor 10. Examples of the good conductor forming the first and second external electrodes 14 and 15 include metal mainly containing nickel (Ni), copper (Cu), palladium (Pd), platinum (Pt), silver (Ag), gold (Au), or the like, and an alloy of those metals.

The first and second external electrodes 14 and 15 may have a single-layer structure or multi-layer structure.

The first and second external electrodes 14 and 15 of the multi-layer structure may be farmed to have a double-layer structure including a base film and a surface film, or a three-layer structure including a base film, an intermediate film, and a surface film, for example.

The base film can be a baked film made of metal mainly containing nickel, copper, palladium, platinum, silver, gold, or the like, or an alloy of those metals, for example.

The intermediate film can be a plating film made of metal mainly containing platinum, palladium, gold, copper, nickel, or the like, or an alloy of those metals, for example.

The surface film can be a plating film made of metal mainly containing copper, tin, palladium, gold, zinc, or the like, or an alloy of those metals, for example.

The body 11 includes a multi-layer chip 16 and side margins 17.

The side margins 17 have a flat plate-like shape extending along the X-Z plane and cover both the side surfaces P and Q of the multi-layer chip 16 that are oriented in the Y-axis direction. A detailed configuration of the side margins 17 will be described later.

The multi-layer chip 16 includes a capacitance forming unit 18 and covers 19. The covers 19 have a flat plate-like shape extending along the X-Y plane and cover both main surfaces of the capacitance forming unit 18 that are oriented in the Z-axis direction.

The side margins 17 and the covers 19 have main functions of protecting the capacitance forming unit 18 and ensuring insulation properties of the periphery of the capacitance forming unit 18.

The capacitance forming unit 18 includes a plurality of first internal electrodes 12 and a plurality of second internal electrodes 13. The first internal electrodes 12 and the second internal electrodes 13 each have a sheet-like shape extending along the X-Y plane and are alternately disposed in the Z-axis direction (first axis direction). The first internal electrodes 12 are connected to the first external electrode 14 and are apart from the second external electrode 15. To the contrary, the second internal electrodes 13 are connected to the second external electrode 15 and are apart from the first external electrode 14.

The first internal electrodes 12 and the second internal electrodes 13 are each formed from a good conductor and function as internal electrodes of the multi-layer ceramic capacitor 10. Examples of the good conductor forming the first and second internal electrodes 12 and 13 include nickel (Ni), copper (Cu), palladium (Pd), platinum (Pt), silver (Ag), gold (Au), and a metal material including an alloy of those metals.

The capacitance forming unit 18 is made of dielectric ceramics. In the multi-layer ceramic capacitor 10, in order to increase capacitances of respective layers made of dielectric ceramics (hereinafter, referred to as dielectric ceramic layers in some cases) provided between the first and second internal electrodes 12 and 13, dielectric ceramics having a high dielectric constant is used as a material forming the capacitance forming unit 18. Examples of the dielectric ceramics having a high dielectric constant include a material having a Perovskite structure containing barium (Ba) and titanium (Ti), which is typified by barium titanate (BaTiO₃). Further, examples of the dielectric ceramics forming the capacitance forming unit 18 may also include a strontium titanate (SrTiO₃) based material, a calcium titanate (CaTiO₃) based material, a magnesium titanate (MgTiO₃) based material, a calcium zirconate (CaZrO₃) based material, a calcium zirconate titanate (Ca(Zr,Ti)O₃) based material, a barium zirconate (BaZrO₃) based material, or a titanium oxide (TiO₂) based material, in addition to the barium titanate based material.

The side margins 17 and the covers 19 are also made of dielectric ceramics. A material of the side margins 17 and the covers 19 only needs to be insulating ceramics, but use of a material similar to the material of the capacitance forming unit 18 leads to improvement in production efficiency and suppression of internal stress in the body 11.

With the configuration described above, when a voltage is applied between the first external electrode 14 and the second external electrode 15 in the multi-layer ceramic capacitor 10, a voltage is applied to the dielectric ceramic layers between the first and second internal electrodes 12 and 13. With this configuration, the multi-layer ceramic capacitor 10 stores charge corresponding to the voltage applied between the first external electrode 14 and the second external electrode 15.

It should be noted that the configuration of the multi-layer ceramic capacitor 10 is not limited to a specific configuration, and a well-known configuration can be used as appropriate in accordance with the size and performance expected for the multi-layer ceramic capacitor 10. For example, the number of first internal electrodes 12 and second internal electrodes 13 in the capacitance forming unit 18 can be determined as appropriate.

1.2 Configuration of Side Margin 17

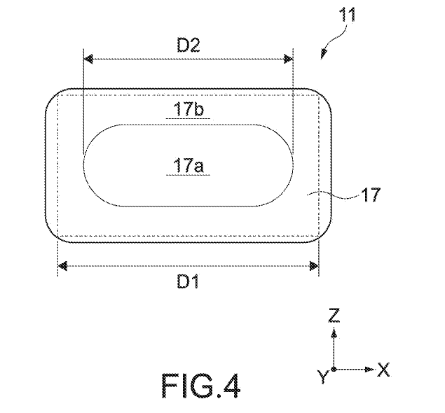

FIG. 4 is a side view of the body 11 when seen from the Y-axis direction. A detailed configuration of the side margin 17 will be described with reference to FIGS. 3 and 4.

The side margin 17 includes a flat portion 171 and a circumferential portion 172.

The flat portion 171 is formed to have a predetermined thickness T in the Y-axis direction (second axis direction). The flat portion 171 is typically formed at the center portion of the side margin 17 along the Z- and X-axis directions. The circumferential portion 172 is formed around the flat portion 171 and formed to have a thickness smaller than the thickness T of the flat portion 171.

This can prevent the side margin 17 from partially protruding, bulging, or the like and provide an appropriate form with which the miniaturization of the multi-layer ceramic capacitor 10 is feasible. Further, since the circumferential portion 172 is formed to be thinner than the flat portion 171, stress between the multi-layer chip 16 and the side margin 17 can be reduced at the circumferential portion 172. This can prevent the side margin 17 from being peeled off and thus ensure the function of the side margin 17.

Further, as shown in FIG. 3, a length H2 of the flat portion 171 along the Z-axis direction may be 30% or more and 70% or less of a length H1 of the multi-layer chip 16 along the Z-axis direction. The “length of the flat portion 171 along the Z-axis direction” described herein refers to a length of the longest portion of the flat portion 171 along the Z-axis direction. Similarly, the “length of the multi-layer chip 16 along the Z-axis direction” refers to a length of the longest portion of the multi-layer chip 16 along the Z-axis direction.

Furthermore, as shown in FIG. 4, a length D2 of the flat portion 171 along the X-axis direction (third axis direction) may be 30% or more and 70% or less of a length D1 of the multi-layer chip 16 along the X-axis direction. The “length of the flat portion 171 along the X-axis direction” described herein refers to a length of the longest portion of the flat portion 171 along the X-axis direction. Similarly, the “length of the multi-layer chip 16 along the X-axis direction” refers to a length of the longest portion of the multi-layer chip 16 along the X-axis direction.

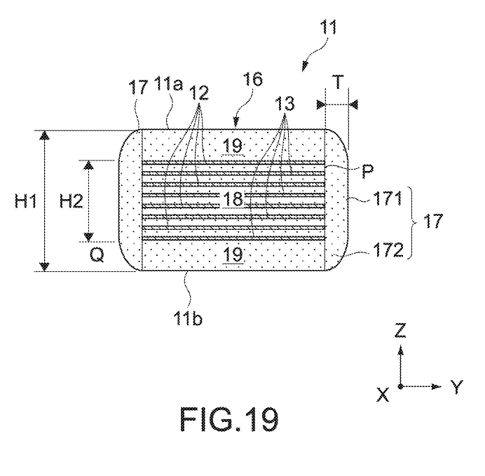

Moreover, as shown in FIGS. 3 and 4, in this embodiment, the circumferential portion 172 of the side margin 17 may cover the circumferences of the main surfaces 11a and 11b of the body 11, the main surfaces 11a and 11b facing each other in the Z-axis direction. Alternatively, as shown in FIG. 19 to be described later, the side margin 17 may be formed so as not to cover the main surfaces 11 a and 11b of the body 11.

The side margin 17 having such a configuration can be formed by application of a ceramic paste and planarization thereof, which will be described later.

1.3. Method of Producing Multi-layer Ceramic Capacitor 10

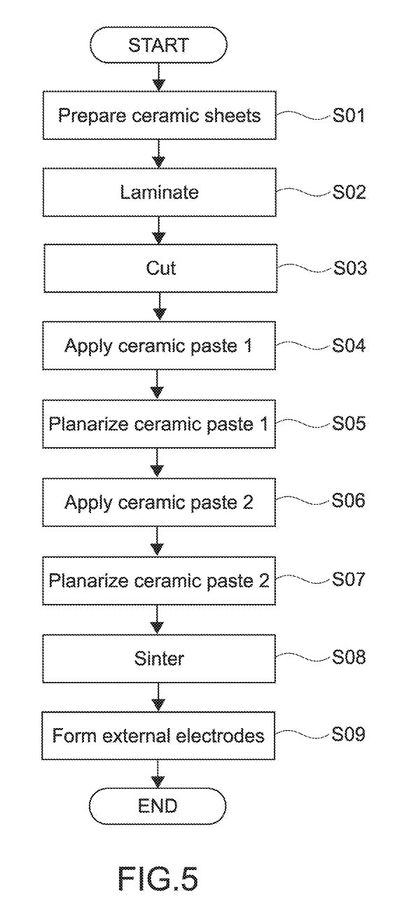

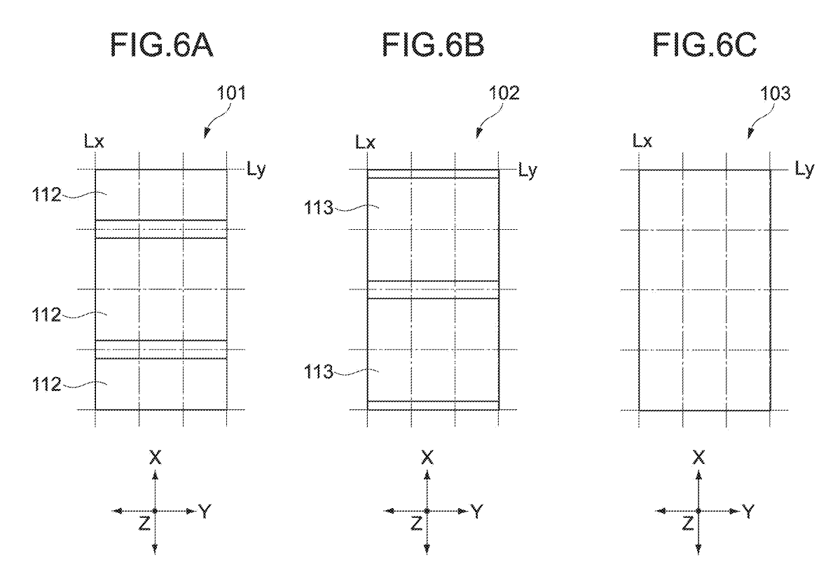

FIG. 5 is a flowchart showing a method of producing the multi-layer ceramic capacitor 10. FIGS. 6A to 17 are views each showing a production process of the multi-layer ceramic capacitor 10. Hereinafter, the method of producing the multi-layer ceramic capacitor 10 will be described along FIG. 5 with reference to FIGS. 6A to 17.

1.3.1 Step S01: Preparation of Ceramic Sheets

In Step S01, first ceramic sheets 101 and second ceramic sheets 102 for forming the capacitance forming unit 18, and third ceramic sheets 103 for forming the covers 19 are prepared.

FIGS. 6A, 6B, and 6C are plan views of the first, second, and third ceramic sheets 101, 102, and 103, respectively. FIG. 6A shows the first ceramic sheet 101, FIG. 6B shows the second ceramic sheet 102, and FIG. 6C shows the third ceramic sheet 103. The first, second, and third ceramic sheets 101, 102, and 103 are configured as unsintered dielectric green sheets and formed into a sheet shape by using a roll coater or a doctor blade, for example.

At the stage of Step S01, the first, second, and third ceramic sheets 101, 102, and 103 are not yet cut into the multi-layer ceramic capacitors 10. FIGS. 6A, 6B, and 6C each show cutting lines Lx and Ly used when the sheets are cut into the multi-layer ceramic capacitors 10. The cutting lines Lx are parallel to the X axis, and the cutting lines Ly are parallel to the Y axis.

As shown in FIGS. 6A, 6B, and 6C, unsintered first internal electrodes 112 corresponding to the first internal electrodes 12 are formed on the first ceramic sheet 101, and unsintered second internal electrodes 113 corresponding to the second internal electrodes 13 are formed on the second ceramic sheet 102. It should be noted that no internal electrodes are formed on the third ceramic sheet 103 corresponding to the covers 19.

The first and second internal electrodes 112 and 113 can be formed using any electrical conductive paste. For formation of the first and second internal electrodes 112 and 113 by use of an electrical conductive paste, a screen printing method or a gravure printing method can be used, for example.

Each of the first and second internal electrodes 112 and 113 is disposed over two areas and extends like a belt in the Y-axis direction. The two areas are adjacent to each other in the X-axis direction and divided by the cutting line Ly. The first internal electrodes 112 are shifted from the second internal electrodes 113 in the X-axis direction by one row including the areas divided by the cutting lines Ly. In other words, the cutting line Ly passing through the center of the first internal electrode 112 passes through an area between the second internal electrodes 113, and the cutting line Ly passing through the center of the second internal electrode 113 passes through an area between the first internal electrodes 112.

1.3.2 Step S02: Lamination

In Step S02, the first, second, and third ceramic sheets 101, 102, and 103 prepared in Step S01 are laminated, to produce a multi-layer sheet 104.

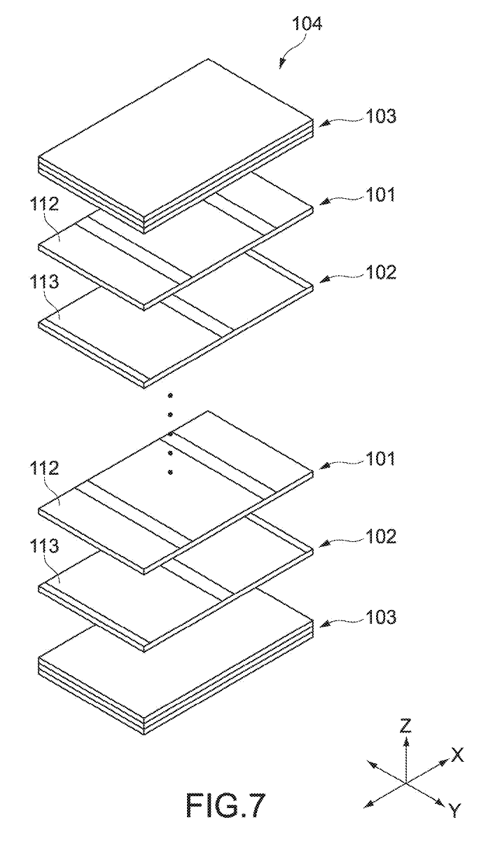

FIG. 7 is a perspective view of the multi-layer sheet 104 obtained in Step S02. For the purpose of description, FIG. 7 shows the first, second, and third ceramic sheets 101, 102, and 103 in an exploded manner. In an actual multi-layer sheet 104, however, the first, second, and third ceramic sheets 101, 102, and 103 are pressure-bonded by hydrostatic pressing, uniaxial pressing, or the like for integration. With this configuration, a high-density multi-layer sheet 104 is obtained. As will be described later, the multi-layer sheet 104 of FIG. 7 is singulated into a plurality of multi-layer chips 116.

In the multi-layer sheet 104, the first ceramic sheets 101 and the second ceramic sheets 102 that correspond to the capacitance forming unit 18 are alternately laminated in the Z-axis direction.

Further, in the multi-layer sheet 104, the third ceramic sheets 103 corresponding to the covers 19 are laminated on the uppermost and lowermost surfaces of the first and second ceramic sheets 101 and 102 alternately laminated in the Z-axis direction. It should be noted that in the example shown in FIG. 7 three third ceramic sheets 103 are laminated on each of the uppermost and lowermost surfaces of the laminated first and second ceramic sheets 101 and 102, but the number of third ceramic sheets 103 can be changed as appropriate.

1.3.3 Step S03: Cutting

In Step S03, the multi-layer sheet 104 obtained in Step S02 is cut to produce unsintered multi-layer chips 116.

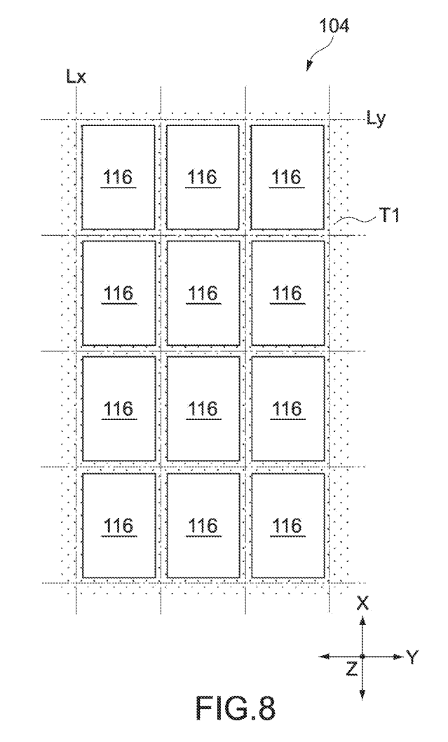

FIG. 8 is a plan view of the multi-layer sheet 104 after Step S03, The multi-layer sheet 104 is cut along the cutting lines Lx and Ly while being attached to a tape T1 as a holding member.

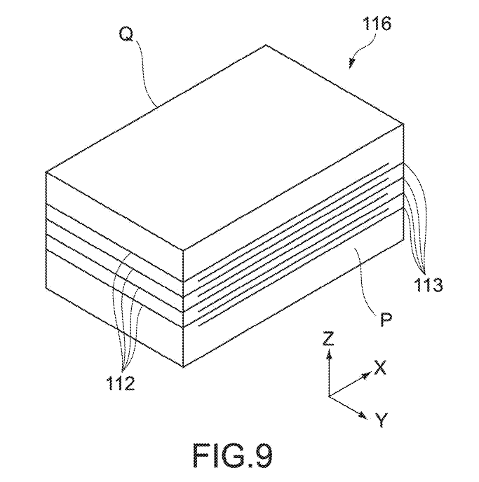

With this configuration, the multi-layer sheet 104 is singulated, and the multi-layer chips 116 shown in FIG. 9 are obtained. In each of the multi-laver chips 116, cut surfaces on which the first and second internal electrodes 112 and 113 are exposed, i.e., the side surfaces P and Q, are formed.

A method of cutting the multi-layer sheet 104 is not limited to a specific method. For example, for the cutting of the multi-layer sheet 104, a technique using various blades can be used. Examples of the blades usable for the cutting of the multi-layer sheet 104 include a push-cutting blade and a rotary blade (e.g., dicing blade). Further, for the cutting of the multi-layer sheet 104, for example, laser cutting or water jet cutting can be used in addition to the technique using various blades.

The cut multi-layer chips 116 are cleansed as needed, to remove grinding dust or the like adhering to the side surfaces P and Q or the like.

1.3.4 Step S04: Application of Ceramic Paste 1

In Step S04, in order to form side margins 117, a ceramic paste is applied to the side surfaces P of the multi-layer chips 116 obtained in Step S03.

In Step S04, a ceramic paste 201p for forming the side margins 117 is prepared. The ceramic paste 201p may contain ceramic powder made of dielectric ceramics and may contain an organic solvent, an organic binder, or the like as appropriate.

Further, in Step S04, the side surfaces P are immersed in the ceramic paste 201p, so that the ceramic paste 201p can be applied to the side surfaces P. This makes it easy to apply the ceramic paste 201p to the side surfaces P. A method of applying the ceramic paste 201p is not limited to the above method. For example, a method of using a roller or the like, injection by a spray method, or the like can be employed.

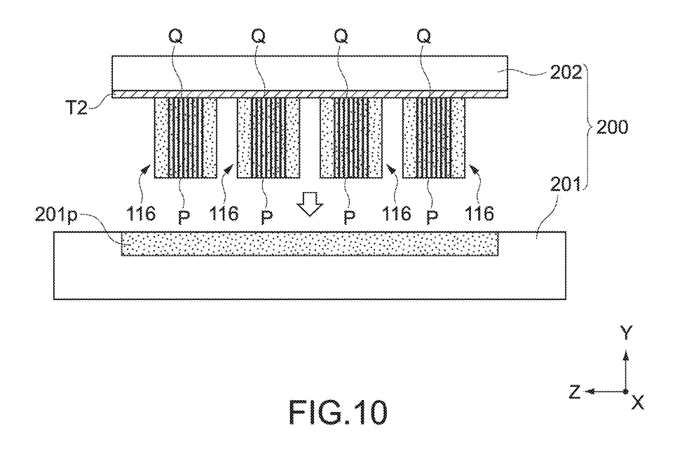

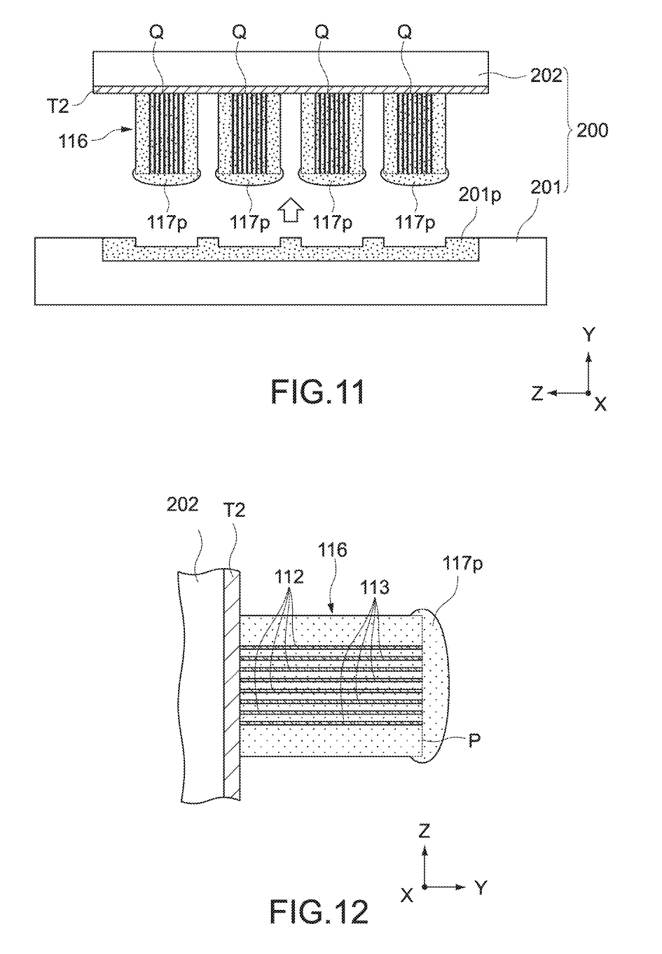

FIGS. 10 and 11 are schematic views each showing a process of applying the ceramic paste to the side surfaces P in Step S04. FIG. 10 shows a state before application (dipping). FIG. 11 shows a state after application (dipping). In Step S04, the multi-layer chips 116 are bonded to a tape T2 from a tape T1.

In Step S04 of this embodiment, a dipping apparatus (dipping coater) 200 is used. The dipping apparatus 200 includes, for example, a container 201 that receives the ceramic paste 201p, and a retainer 202 that retains the multi-layer chips 116 via the tape T2. The dipping apparatus 200 also includes a drive mechanism, a controller, and the like that are not shown in the figures. The container 201 and the retainer 202 are disposed to face each other in the Y-axis direction, for example.

At the dipping, on the basis of an input operation of a user, a preset program, or the like, the retainer 202 moves close to the container 201 in a direction indicated by an outlined arrow of FIG. 10 (here, downward in the Y-axis direction). Thus, the side surfaces P of the multi-layer chips 116 serving as application targets are immersed in the ceramic paste 201p. After the immersion, the retainer 202 moves away from the container 201 in a direction indicated by an outlined arrow of FIG. 11 (here, upward in the Y-axis direction). Thus, the multi-layer chips 116 are pulled out from the ceramic paste 201p.

Such a method makes it possible to simultaneously apply the ceramic paste 201p to the multi-layer chips 116 and enhance productivity in application treatment.

FIG. 12 is a cross-sectional view of the multi-layer chip 116 immediately after Step S04. It should be noted that, for the purpose of description, FIG. 12 shows the multi-layer chip 116 rotated in a counterclockwise direction by 90° from the state shown in FIG. 11.

As shown in FIG. 12, a ceramic paste 117p is applied to the side surface P. The center portion of the ceramic paste 117p bulges in the Y-axis direction due to the surface tension of the ceramic paste 117p. In other words, in the ceramic paste 117p immediately after the application, the center portion is thick and the circumferential portion is thin along the Y-axis direction. If the ceramic paste 117p with this form is sintered, the thickness of the multi-layer ceramic capacitor 10 along the Y-axis direction becomes large. This makes it difficult to form the multi-layer ceramic capacitor 10 in a desired size. Further, since the circumferential portion of the side margin 17 becomes thin, this may make it impossible to sufficiently ensure insulation properties of the first and second internal electrodes 12 and 13 in the circumferential portion and may cause failures.

In this regard, in this embodiment, the ceramic pastes 117p are applied to the side surfaces P and then planarized, to form the side margins 117 with a desired form.

It should be noted that, after Step S04, the applied ceramic pastes 117p may be dried. This makes it easy to deform the ceramic pastes 117p into a desired form in the next Step S05. Conditions for drying treatment can be adjusted as appropriate in accordance with properties of the ceramic pastes 117p or pressing conditions.

1.3.5 Step S05: Planarization of Ceramic Paste 1

In Step 505, the applied ceramic pastes 117p are pressed toward the side surfaces P and then planarized to form the side margins 117.

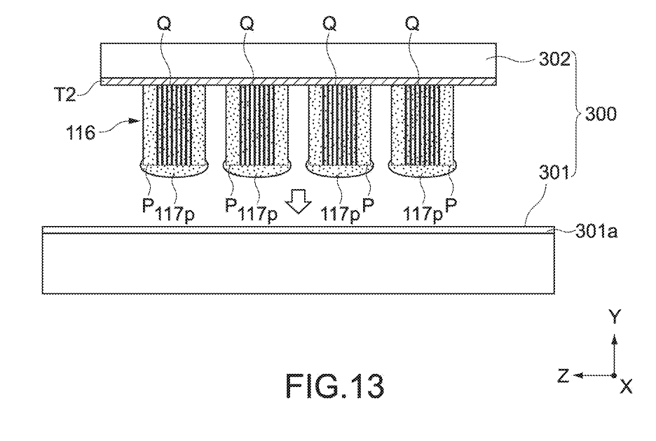

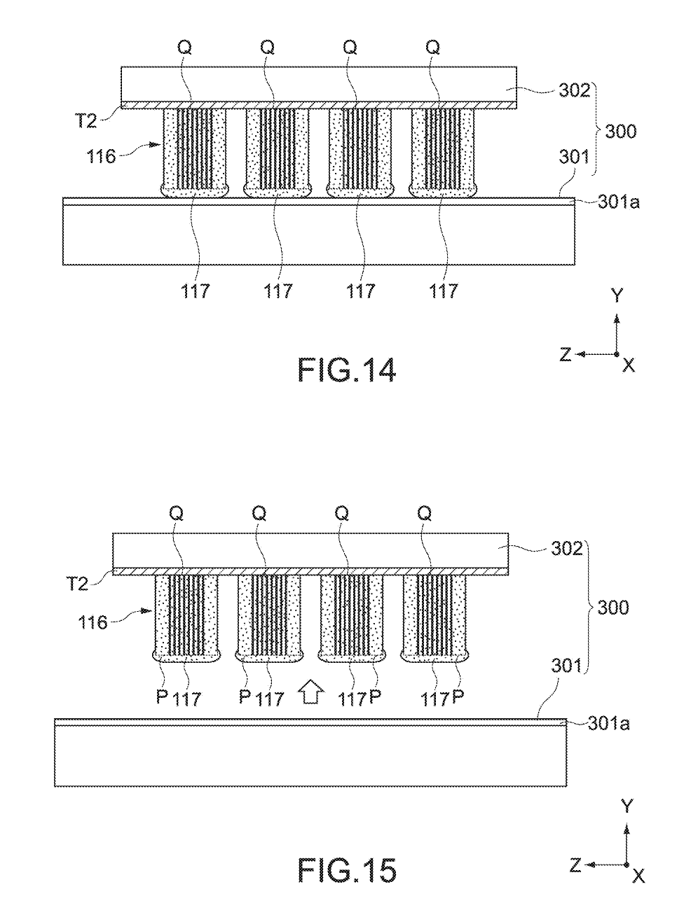

FIGS. 13 to 15 are schematic views each showing a process of planarizing the ceramic pastes 117p in Step S05. FIG. 13 shows a state before pressing. FIG. 14 shows a state at pressing. FIG. 15 shows a state after pressing.

In Step S05 of this embodiment, a pressing apparatus 300 is used. The pressing apparatus 300 includes, for example, a flat plate 301 that presses the ceramic pastes 117p, and a retainer 302 that retains the multi-layer chips 116 via the tape T2. The pressing apparatus 300 also includes a drive mechanism, a controller, and the like that are not shown in the figures. The flat plate 301 and the retainer 302 are disposed to face each other in the Y-axis direction, for example.

In Step S05, the ceramic pastes 117p are pressed using the flat plate 301, so that the ceramic pastes 117p can be planarized. The configuration of the flat plate 301 is not particularly limited as long as failures such as adhering to the ceramic pastes 117p do not occur. For example, the flat plate 301 may include a release layer 301a that enhances release properties of the ceramic pastes 117p. The release layer 301a is formed by surface treatment for enhancing the release properties of the ceramic pastes 117p. For example, the release layer 301a may be formed by water-repellent treatment using fluorine, a silicone resin, and the like, and may be a film containing diamond-like carbon or the like. Alternatively, the release layer 301a may be a film containing another release agent, another lubricant agent, or the like. Using the flat plate 301, the multi-layer chips 116 can be simultaneously subjected to pressing treatment.

With reference to FIGS. 13 and 14, at the pressing, on the basis of an input operation of the user, a preset program, or the like, the retainer 302 moves close to the flat plate 301 in a direction indicated by an outlined arrow of FIG. 13 (here, downward in the Y-axis direction). Thus, the ceramic pastes 117p are pressed to the flat plate 301. In other words, in this example, the ceramic pastes 117p are pressed in the Y-axis direction orthogonal to the side surfaces P. Conditions for pressing (pressing force, pressing time, etc.) can be adjusted as appropriate in consideration of the viscosity, thickness, or the like of the ceramic pastes 117p.

With reference to FIG. 15, after the pressing, the retainer 302 moves away from the flat plate 301 in a direction indicated by an outlined arrow of FIG. 15 (here, upward in the Y-axis direction).

Thus, the side margins 117 are formed on the side surfaces P.

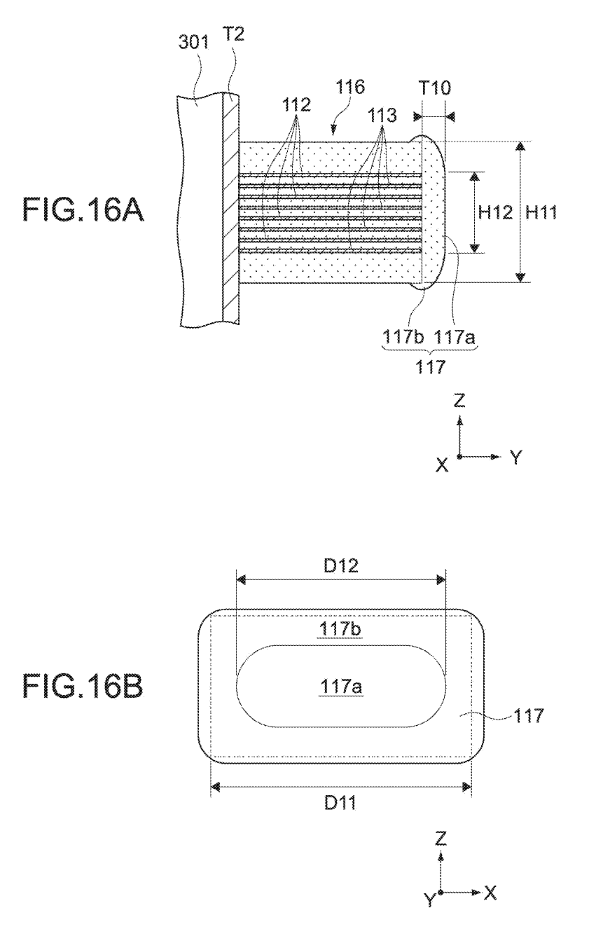

FIG. 16A is a cross-sectional view of the multi-layer chip 116 including the side margin 117 after Step S05. FIG. 16B is a plan view of the side margin 117 when seen from the Y-axis direction. It should be noted that, for the purpose of description, FIG. 16A shows the multi-layer chip 116 rotated in a counterclockwise direction by 90° from the state shown in FIG. 15.

The side margin 117 includes a flat portion 117a and a circumferential portion 117b.

The flat portion 117a is a flat portion that is pressed by the flat plate 301 and thus uniformly formed to have a predetermined thickness T10 in the Y-axis direction. Typically, the thickness T10 is determined by a distance between the side surface P and the surface of the flat plate 301 when the side surface P and the surface of the flat plate 301 come closest to each other. The flat portion 117a is formed such that a bulging portion of the ceramic paste is pressed to flow to the circumference (see FIG. 12). Thus, the flat portion 117a is typically formed at the center portion of the side margin 117 along the Z-axis direction and the X-axis direction.

The circumferential portion 117b is a portion that is formed when the bulging portion is crushed and the ceramic paste flows to the circumference. The circumferential portion 117b is formed around the flat portion 117a, The thickness of the circumferential portion 117b in the Y-axis direction is formed to be smaller than the thickness of the flat portion 117a in the Y-axis direction.

With reference to FIG. 16A, in Step S05, the ceramic paste 117p can be pressed such that a length H12 of the flat portion 117a along the Z-axis direction is 30% or more and 70% or less of a length H11 of the multi-layer chip 116 along the Z-axis direction. The “length H12 of the flat portion 117a along the Z-axis direction” described herein refers to a length of the longest portion of the flat portion 117a along the Z-axis direction. Similarly, the “length H11 of the multi-layer chip 116 along the Z-axis direction” refers to a length of the longest portion of the multi-layer chip 116 along the Z-axis direction.

Further, with reference to FIG. 16B, in Step S05, the ceramic paste 117p can be pressed such that a length D12 of the flat portion 117a along the X-axis direction is 30% or more and 70% or less of a length D11 of the multi-layer chip 116 along the X-axis direction. The “length D12 of the flat portion 117a along the X-axis direction” described herein refers to a length of the longest portion of the flat portion 117a along the X-axis direction. Similarly, the “length D11 of the multi-layer chip 116 along the X-axis direction” refers to a length of the longest portion of the multi-layer chip 116 along the X-axis direction.

Adjusting the pressing conditions so as to obtain the form as described above can suppress adhesion of the ceramic pastes 117p to the surface of the flat plate 301 and form the side margins 117 having a desired form and a sufficient protection function for the first and second internal electrodes 112 and 113.

Further, a dimensional ratio of the side margins 17 and the multi-layer chip 16 after being subjected to sintering is substantially the same as a dimensional ratio of the side margins 117 and the multi-layer chip 116 before being subjected to sintering. As a result, pressing is performed such that the length of the flat portion 117a and the length of the multi-layer chip 116 have the ratio as described above, and the ratio of the length of the multi-layer chip 16 to the length of the flat portion 117a can thus be adjusted to fall within the range described above also in the sintered body 11.

It should be noted that, after Step S05, the side margins 117 may be dried. This can suppress deformation of the side margins 117 on the side surfaces P, which are retained by the dipping apparatus 200 and the pressing apparatus 300 via the tape or the like in the next Steps S06 and S07. Conditions for drying treatment can be adjusted as appropriate in accordance with the properties of the side margins 117 or a retaining state of the dipping apparatus 200 and the pressing apparatus 300.

1.3.6 Step S06: Application of Ceramic Paste 2

In Step S06, the ceramic pastes 117p are applied to the side surfaces Q of the multi-layer chips 116 obtained in Step S05. The application of the ceramic pastes 117p to the side surfaces Q in Step S06 can be performed similarly to the application of the ceramic pastes 117p to the side surfaces P in Step S04.

1.3.7 Step S07: Planarization of Ceramic Paste 2

In Step S07, the ceramic pastes 117p applied in Step S07 are pressed toward the side surfaces Q and then planarized, to form the side margins 117. The planarization of the ceramic pastes 117p to the side surfaces Q in Step S07 can be performed similarly to the planarization of the ceramic pastes 117p to the side surfaces P in Step S05. In other words, through this step, the side margins 117 on the side surfaces Q are also formed similarly to the side margins 117 shown in FIGS. 16A and 16B.

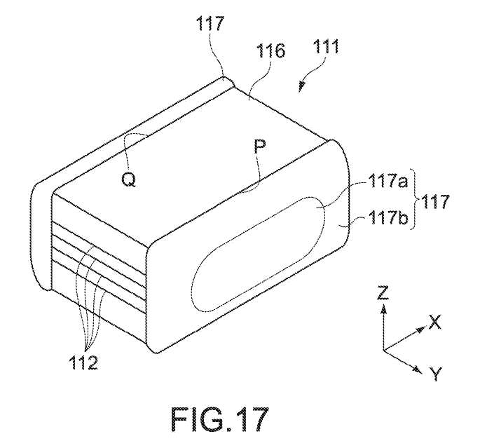

As described above, an unsintered body 111 as shown in FIG. 17 is obtained.

A form of the unsintered body ill can be determined in accordance with a form of a sintered body 11. For example, in order to obtain the body 11 with the size of 1.0 mm×0.5 mm×0.5 mm, the unsintered body 111 with the size of 1.2 mm×0.6 mm×0.6 mm can be produced.

1.3.8 Step S08: Sintering

In Step S08, the unsintered body 111 obtained in Step S07 is sintered to produce the body 11 of the multi-layer ceramic capacitor 10 shown in FIGS. 1 to 3. Sintering can be performed in a reduction atmosphere or a low-oxygen partial pressure atmosphere, for example.

1.3.9 Step S09: Formation of External Electrodes

In Step S09, the first external electrode 14 and the second external electrode 15 are formed on the body 11 obtained in Step S08, to produce the multi-layer ceramic capacitor 10 shown in FIGS. 1 to 3.

In Step S09, first, an unsintered electrode material is applied so as to cover one of the end surfaces of the body 11 and then applied so as to cover the other one of the end surfaces of the body 11, both the end surfaces being oriented in the X-axis direction. The unsintered electrode materials applied to the body 11 are subjected to baking in a reduction atmosphere or a low-oxygen partial pressure atmosphere, for example, to form base films on the body 11 On the base films baked onto the body 11, intermediate films and surface films are formed by plating such as electrolytic plating. Thus, the first external electrode 14 and the second external electrode 15 are completed.

It should be noted that part of the treatment in Step S09 described above may be performed before Step S08. For example, before Step S08, the unsintered electrode material may be applied to both the end surfaces of the unsintered body 111 that are oriented in the X-axis direction, and in Step S08, the unsintered body 111 may be sintered and, simultaneously, the unsintered electrode material may be baked to form base layers of the first external electrode 14 and the second external electrode 15.

### 2. Other Embodiments

While the embodiment of the present invention has been described, the present invention is not limited to the embodiment described above, and it should be appreciated that the present invention may be variously modified.

For example, the steps shown in FIG. 5 may be performed in different order as needed. In one example, the unsintered multi-layer chips 116 obtained by the singulation in Step S03 may be sintered, and the sintered multi-layer chips 16 may be provided with the side margins 117. In this case, the sintered multi-layer chips 16 can be subjected to Steps S04 to S08.

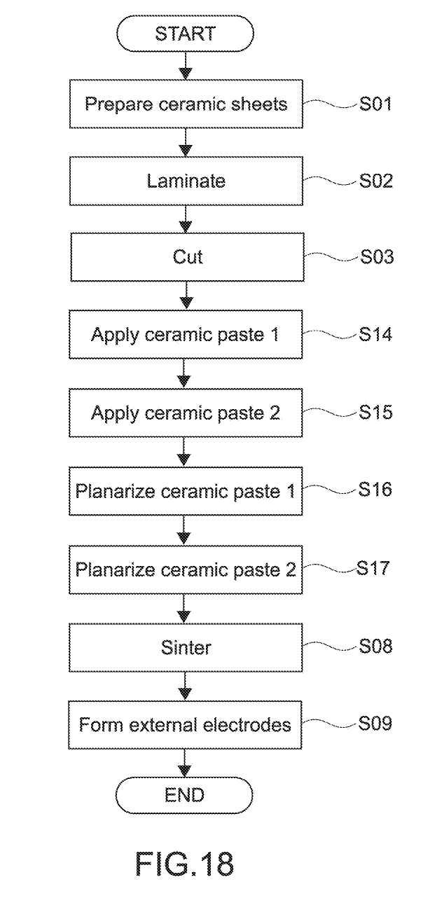

Further, as shown in FIG. 18, the ceramic paste may be applied to the side surfaces P (Step S14) and then applied to the side surfaces Q (Step S15) before planarization, and the planarization of the side surfaces P (Step S16) and the planarization of the side surfaces Q (Step S17) may be subsequently performed in the stated order. Furthermore, the ceramic pastes may be dried as appropriate between those steps. This makes it possible to continuously perform the steps by the same apparatus and efficiently produce the multi-layer ceramic capacitors 10.

It should be noted that, also in this modified example, the drying treatment for the ceramic pastes 117p or the side margins 117 may be performed as needed after Steps S14, S15, and S16.

The embodiment described above has described that the side surfaces P and Q are immersed in the ceramic paste 201p to apply the ceramic paste 201p, but the present invention is not limited thereto. A method of using a roller or the like, injection by a spray method, or the like can be employed.

Further, the flat plate 301 including the release layer 301a as shown in FIGS. 13 to 15 has been described, but the flat plate 301 is not limited thereto and may include no release layer.

Furthermore, the pressing treatment is not limited to a method using a flat plate as long as the ceramic pastes 117p can be pressed toward the side surfaces P and Q and then planarized.

Moreover, as shown in FIG. 19, the configuration in which the circumferential portion 172 of the side margin 17 does not cover the circumferences of the main surfaces 11a and 11b of the body 11 may be provided. Such side margins 17 can be formed by, for example, immersing only the side surfaces P and Q in the ceramic paste 201p or applying the ceramic paste to the side surfaces P and Q using a roller or a spray. Alternatively, after the body 111 having the configuration in which the circumferential portions 117b of the side margins 117 cover the circumferences of the main surfaces as shown in FIG. 17 is produced, treatment of removing the portions covering the circumferences of the main surfaces of the side margins 17 (117) may be performed before sintering or after sintering.

In addition, in the embodiment described above, the multi-layer ceramic capacitor has been described as an example of a multi-layer ceramic electronic component, but the present invention can be applied to any other multi-layer ceramic electronic components in which internal electrodes are alternatively disposed to form pairs. Examples of such multi-layer ceramic electronic components include a piezoelectric element.

What is claimed is:

1. A method of producing a Multi-layer ceramic electronic component, the method comprising:
preparing a multi-layer chip including
ceramic layers laminated in a first axis direction,
internal electrodes disposed between the ceramic layers, and
a side surface on which the internal electrodes are exposed;
applying a ceramic paste to the side surface; and
pressing the applied ceramic paste toward the side surface to planarize the applied ceramic paste.

2. The method of producing a multi-layer ceramic electronic component according to claim 1, wherein
the side surface is immersed in the ceramic paste to apply the ceramic paste to the side surface.

3. The method of producing a multi-layer ceramic electronic component according to claim 1, wherein
the ceramic paste is pressed with a flat plate to planarize the ceramic paste.

4. The method of producing a multi-layer ceramic electronic component according to claim 3, wherein
the flat plate includes a release layer on a surface of the flat plate, the release layer enhancing release properties of the ceramic paste.

5. The method of producing a multi-layer ceramic electronic component according to claim 1, wherein
the ceramic paste is applied and then dried.

6. The method of producing a multi-layer ceramic electronic component according to claim 1, wherein
a bulging portion of the ceramic paste is pressed to flow to a circumference of the ceramic paste, to planarize the ceramic paste.

7. The method of producing a multi-layer ceramic electronic component according to claim 6, wherein
a length of the planarized portion along the first axis direction is 30% or more and 70% or less of a length of the multi-layer chip along the first axis direction.

8. The method of producing a multi-layer ceramic electronic component according to claim 6, wherein
the ceramic paste is pressed in a second axis direction to be planarized, the second axis direction being orthogonal to the side surface, and
a length of the planarized portion along a third axis direction is 30% or more and 70% or less of a length of the multi-layer chip along the third axis direction, the third axis direction being orthogonal to the first axis direction and the second axis direction.

9. A multi-layer ceramic electronic component, comprising:
a multi-layer chip including
ceramic layers laminated in a first axis direction,
internal electrodes disposed between the ceramic layers, and
a side surface on which the internal electrodes are exposed; and
a side margin that is made of dielectric ceramics and provided on the side surface, the side margin including
a flat portion having a predetermined thickness in a second axis direction, the second axis direction being orthogonal to the side surface, and
a circumferential portion that is formed around the flat portion and has a thickness smaller than the thickness of the flat portion in the second axis direction.

10. The multi-layer ceramic electronic component according to claim 9, wherein
a length of the flat portion along the first axis direction is 30% or more and 70% or less of a length of the multi-layer chip along the first axis direction.

11. The multi-layer ceramic electronic component according to claim 9, wherein
a length of the flat portion along a third axis direction is 30% or more and 70% or less of a length of the multi-layer chip along the third axis direction, the third axis direction being orthogonal to the first axis direction and the second axis direction.
